(19) United States
(12) Patent Application Publication
(10) Pub. No.: US 2009/0186679 A1
(43) Pub. Date: Jul. 23, 2009

(54) PREDICTION GAME SYSTEM AND METHOD

(76) Inventors: James Christopher Irvine, Dothan, AL (US); Christopher Daniel Krygier, Phoenix, AZ (US); Chadwick Lloyd Porter, Glendale, AZ (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 12/357,130

(22) Filed: Jan. 21, 2009

Related U.S. Application Data
(60) Provisional application No. 61/022,849, filed on Jan. 23, 2008.

(51) Int. Cl. A63F 9/24; A63F 13/00

(52) U.S. Cl. 463/16; 463/25

(57) ABSTRACT

A game executed on a data processing system receives one or more prediction selections from participants of possible outcomes expected for an event such as a sports game. Data regarding the event (e.g., historical data) is stored in a database or other form of data storage in memory. At least one of the prediction selections received from the participants is provided after the start of the event. A plurality of prediction factors are stored, and a model including one or more rules uses the plurality of prediction factors. During the event, participants are provided with actual results from the event that are related to the prediction selections of the participants.

### RELATED APPLICATION

This application claims priority to U.S. Provisional Application No. 61/022,849, filed Jan. 23, 2008 (titled PREDICTION GAME SYSTEM AND METHOD by James Christopher Irvine et al.), the contents of which are incorporated herein by reference in its entirety.

### FIELD

At least some embodiments disclosed herein relate to data processing in general, and more particularly, but not limited to, providing a game for predicting possible outcomes for an event.

### BACKGROUND

Many systems are configured to accept wagers on the outcome of an event or allow participation in a game of chance. However, these systems are often very limited with respect to user interaction for guessing or predicting a certain outcome. Such constraints are typically a function of the ability to effectively communicate in social networks, physical proximity, technology, organization, time, capital, the complexity of the rules governing an event or other scenario, etc.

For example, a participant attending or watching an event, show, meeting or process can communicate a prediction of what may occur next by talking to, emailing, calling, sending a text message or otherwise communicating to a few people. In fact, an organized group of people may be able to agree upon a set of rules, develop a scoring routine or turn the act of predicting future events into a fun game. However, the ability to organize such a game becomes increasingly difficult as events that unfold influence the probability of future events. For example, some previous forecasts may be rendered impossible or illogical by the most recent event, and therefore, should be eliminated as possibilities for future forecasts or the probabilities and payouts of certain future outcomes may need to be adjusted in light of the most recent event. Gathering, generating and coordinating the relevant data in order to enable prediction gaming as any event unfolds is typically cost prohibitive and time prohibitive. For example, a system and method for gaming with an entire concert audience to predict the song that will be performed next is not possible because it is too complex to organize participants, agree to the rules, gather predictions and keep score in real time or organize the input.

### BRIEF DESCRIPTION OF THE DRAWINGS

The embodiments are illustrated by way of example and not limitation in the figures of the accompanying drawings in which like references indicate similar elements.

FIGS. 1-4 show a player database designed around objects and their attributes, and the relationships between objects, according to one embodiment.

FIGS. 5-6 show an example of a prediction game for an NFL draft, according to one embodiment.

### DETAILED DESCRIPTION

The present disclosure includes a system and method for gathering, generating and coordinating data in order to enable prediction gaming as any event unfolds. The prediction system is implemented to provide a gaming experience to participants interested in predicting the results of award shows, radio station play lists, live musical performances, political elections, game shows, reality television shows, legislative votes, financial market data, corporate meetings, social gatherings, sports tournaments (i.e. tennis and NCAA Basketball and the like). The system and method includes gathering the data about the event, developing the prediction factors that influence selection as the event unfolds, implementing the process or rules that dictate such selection scenarios, coordinating individuals that wish to participate in predicting results and/or communicating iteratively with the participants during the selection process. The system and method enable gaming with hundreds or thousands of participants to predict who is going to be picked next in the National Football League (NFL) Draft, the National Basketball Association (NBA) Draft, the Major League Baseball (MLB) Draft, the College Football bowl selection process, the Academy Awards or any sports or Award selection process. Similarly, the system and method enables gaming with an entire concert audience to predict the song that will be performed next.

In prior art systems, fans were typically accustomed to looking at static prediction scenarios (i.e. models that do not use real-time information to recalculate likelihoods as an event progresses). For instance, if a participant completed a mock draft prediction form or an award show prediction form, once the event started, the participant was locked into the choices submitted at the outset of the event. In one embodiment, the prediction system is a dynamic prediction system which communicates with a participant interactively as an event progresses. Participants use a gaming device such as a mobile phone or personal data assistant to communicate their prediction of what will occur just prior to the next announcement of an actual result.

In one embodiment, the prediction system dynamically adjusts the likelihood that any particular selection will be chosen as a function of previous selections during the same event. The prediction system employs predictive bases to change and interpret data during the progression of a draft, award show, song list or other event that lends itself to iterative predictions. Many prediction scenarios enabled by the prediction system include the interplay of the selection process. One embodiment involves a series of interrelated events where one event is directly dependent on the next. The previous selections may influence the next selection. In one embodiment, the selection scenario involves a finite set of mutually exclusive selections. For example, in the NFL draft, there is a finite set of players eligible to be drafted, and once a player is drafted by a team, he cannot be drafted again by another team.

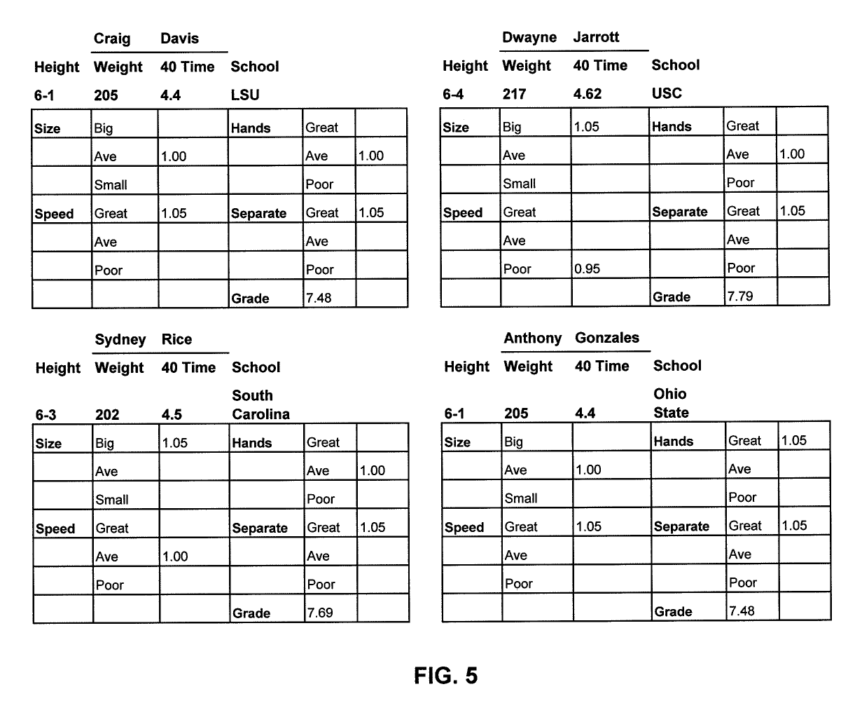

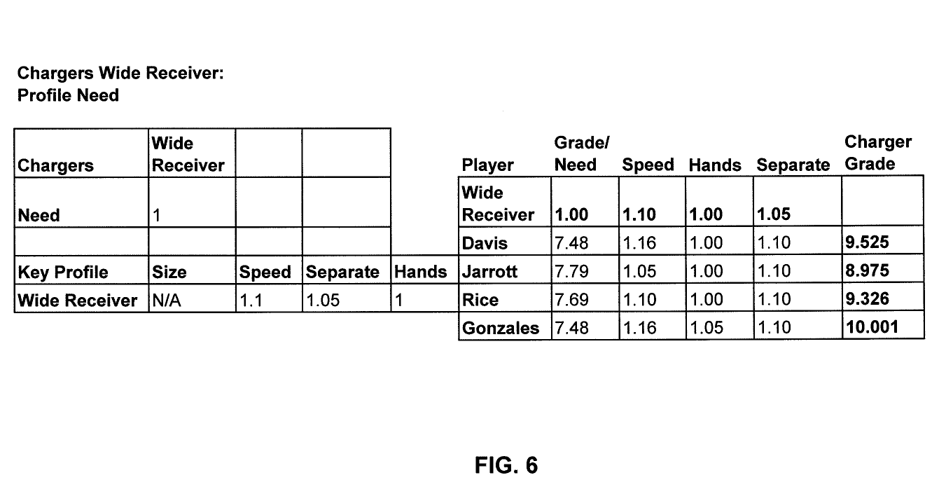

As further explained with reference to FIGS. 5-6 below, one embodiment includes predicting the exact player that may be chosen in the NFL draft by a team in any particular draft position. For example, to predict which player will be taken by a team that has the overall fifth pick in the draft is difficult before the beginning of the draft. However, given access to the proper data, the probability that any particular player may be drafted by that team will change as a function of the choices made in first, second, third and fourth picks. The team picking fifth may have targeted a quarterback, but then abandon that strategy if a defensive end that the team did not think would be available is indeed still available when it is that team's turn to designate a pick. Similarly, if a team had planned to take a quarterback with the fifth pick, but as the draft progresses, the top four quarterbacks are selected in each of the first four picks, that team may decide to take a player who plays a different position (e.g. select a defensive end instead) or may elect to trade their selection rights in the fifth slot for the right to choose more players later in the draft. Therefore, the prediction system predicts the likelihood that any given player will be selected by any given team using a dynamic model because such a complex forecast is unsuitable for static models. Furthermore, for a participant predicting the specific outcome of a multi-outcome event, it is much more engaging and entertaining to interactively provide predictions in concert with an event's progress, as opposed to making only one set of predictions at the outset of an event.

In one embodiment, the prediction system accepts a prediction and a confidence indicator from a participant. The prediction includes the forecast of the actual result that will occur for a given selection. The confidence indicator includes any system of allocating value, or weighting the prediction. The confidence indicator may be referred to as a “widget-based investment.” In one embodiment, the widget-based investment includes allocating points to a particular selection, while in a different embodiment, the widget-based investment involves bets, wagers and/or the like.

In one embodiment, the prediction system assesses participant prediction accuracy and calculates each participant's scores for a game as the event progresses. The prediction system tracks participant accuracy as each event unfolds, which enables the determination of prediction winners as the event unfolds. Designating prizes as the event unfolds is important from a sponsor's perspective because it keeps a participant's focus. The prediction system takes predicting results to the next level by reducing or eliminating the random awards and allowing knowledgeable participants to use their passion and knowledge of the event to win prizes while the event itself is still occurring. At the same time, the prediction system reduces or eliminates the complexity of organizing, initiating, conducting, tracking and scoring a forecast-based game.

In one embodiment, the prediction system accounts for “real time interaction” between events and the fans that view the event. This feature allows service providers that implement the prediction system to partner with large companies and advertisers to create huge national giveaways.

The prediction system is capable of implementation in a variety of different hardware, software and database configurations and the interplay of these elements can be executed in a variety of methods. In one embodiment, the participant communicates with the prediction system through any device (e.g. a gaming device) capable of communicating with the prediction system which may include, for example, a cell phone, computer, or other device discussed herein. The gaming device receives the initial text or email from the prediction system and prompts the participant to respond.

The communication device is configured to facilitate collecting, receiving and transmitting data to the gaming device. A central processing module facilitates one or more of: directs incoming data to the proper database; reads rules and process flow information from the game database and intelligent cartridges; accepts entry of expert forecasts and adjustment of forecast factors and sends this information to the proper historical and game databases; and performs the logic necessary to operate the prediction system. Intelligent cartridges or modules (“cartridge”) contain the logic for the various games and are implemented on the prediction system. The cartridges facilitate one or more of: calculating and tallying scores according to scoring rules; updating participant prediction information; utilizing the Prediction Game Forecast Engine (PGFE) to generate probabilities of future events (e.g. the next draft pick, the next award, the next song, etc.); calculating odds and payouts; and triggering the central processing module to transmit messages and prompts to the end user.

With the prediction system, it is easy to “game” any event. The PGFE enables “real time” calculation of any event dynamic. The prediction system tracks not only results, but trends and patterns for any event which includes patterns. The prediction system sends these forecasts to game participants and allows them to “wager” on the event. This enables the prediction system to take almost any variable imaginable and adjust the prediction system Forecast Engine (PGFE) by changing the weight of the variables to increase the accuracy of predictions.

The PGFE models the complexities of the decision-making and selection logic that underlies complex real-life selection processes. For example, in one embodiment involving predicting the players that will be chosen in a sports league draft, the prediction system maintains a database of players, team needs, draft strategies, opposition drafting strategies, opposition team needs, strategic value of particular play skills to a team's overall strategy, and other useful factors into account and quickly analyzes the information to reduce it to a set of probable selections that may occur. In one embodiment, the prediction system uses historical data, forecasting methods and expert opinion to generate predictive factors.

In one embodiment, the PGFE utilizes player ratings, along with physical and mental skill sets compiled by experts, and matches them to a team's historical preference of the types of players it prefers, along with the appropriate systems (e.g. the 3-4 defense or the West Coast offense) the team runs. The PGFE implements complex forecasting methods to use this data to create unique lists of players based on how they may fit with a team versus how they fit an overall scheme. In one embodiment, the PGFE considers not only the needs of each team, but how those needs combine with the rest of the league's needs to give an economy quotient and factor in the decision makers' (e.g. the teams making the draft selections) own thought process.

In one embodiment, the prediction system utilizes multiple separate databases. These databases need not be substantially similar to each other, though in one embodiment, interconnections between the data exist that facilitate creating one final result that is communicated to the participants. Databases include, for example:
A database to store player profile and account information; this database essentially houses certain players' personal information, specific game information and other account information;
A database to store game rules, parameters, historical data and data about the events that occur as the game unfolds;
A database to store the entities and the order of steps for the various multi-step selection events (e.g. the categories and the order in which each category will be announced during an awards show);
A database that stores predictive factors and the economy of the various options for a given event situation (e.g. information on the type of player a team needs would influence the economy of choice if that team is selecting next in a draft situation);
A database that tracks scores and distributes information.

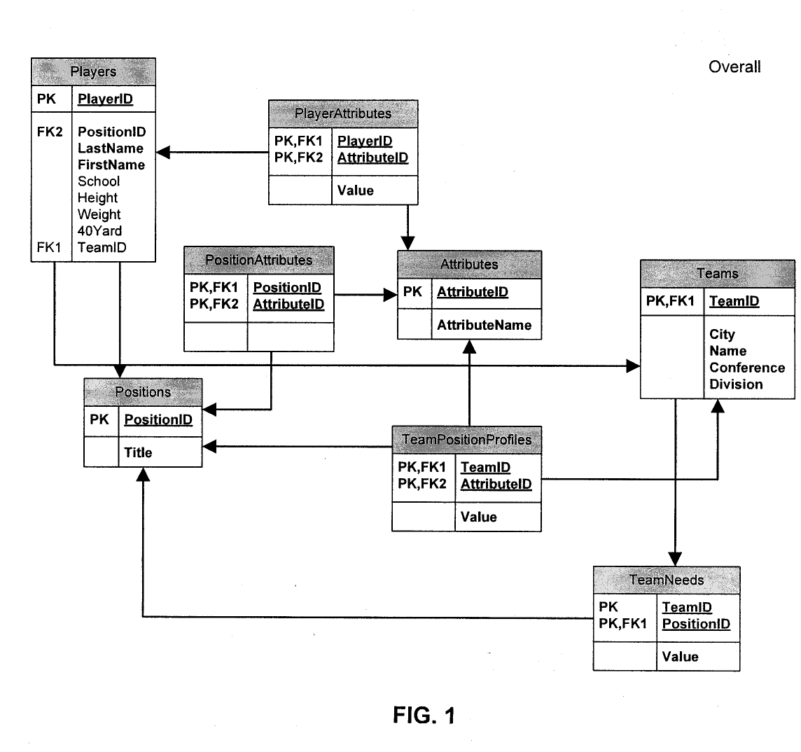

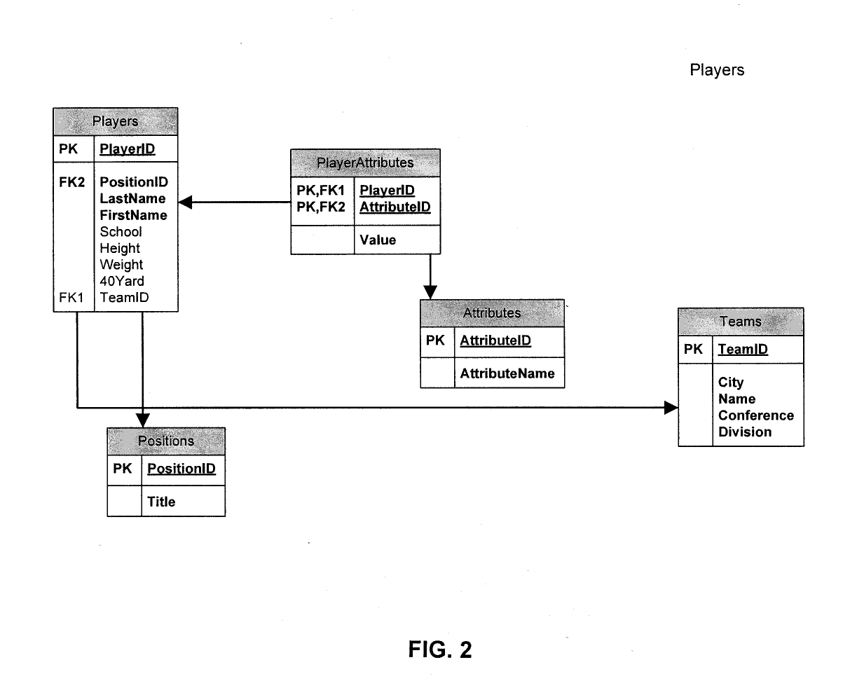

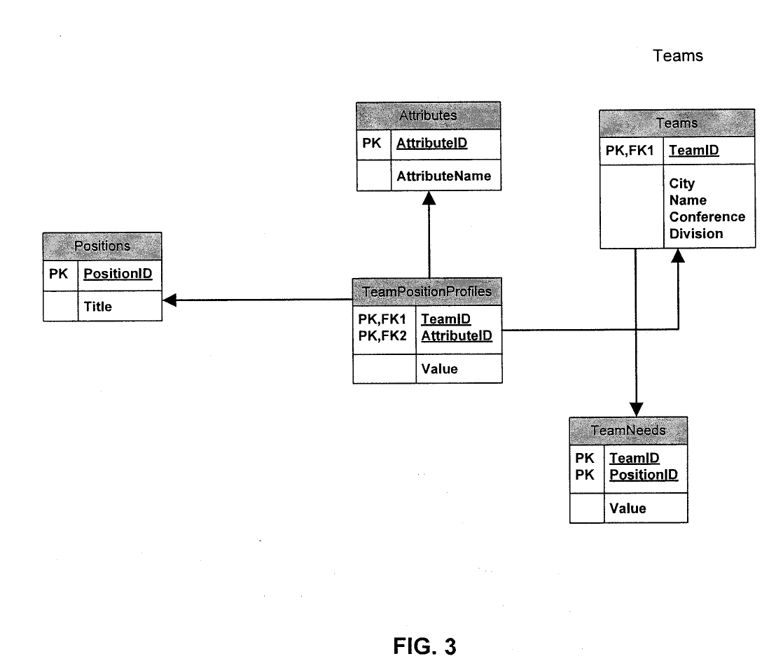

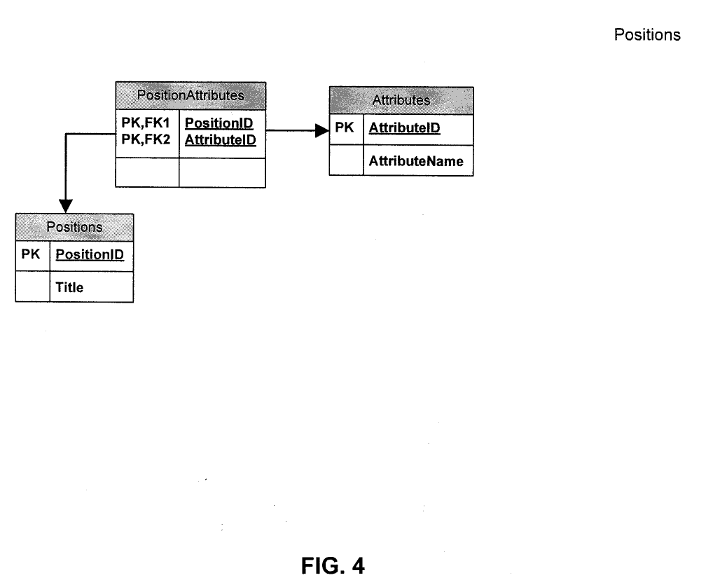

As further illustrated in FIGS. 1-4, in one embodiment, the player database is designed around objects and their attributes and the relationships between objects. Objects in the player database include players, teams, positions and team position profiles, and in a representative embodiment the specific entity relationships defined within the database aid the PGFE in generating accurate predictions rapidly.

In one embodiment, the gaming device does not independently perform any data processing functions or perform any logic that is specific to the prediction system, nor does the gaming device independently execute display logic that is specific to the prediction system. In one embodiment, the prediction system is implemented in a casino environment.

In one embodiment, the prediction system forecasts results for non-competitive events. Historical data may be used to predict future outcomes including using historical data in conjunction with expert opinion to predict future outcomes. In one embodiment, the prediction system receives input in alpha and numeric form. In one embodiment, the prediction system receives a prediction and evaluates the accuracy of the prediction in binary fashion (i.e. the prediction is either correct or incorrect).

In one embodiment, a participant can define a set of participants eligible for a particular game. For example, the attendees of an Academy Awards show party define a “custom” game to compete against each other for predicting the winners of the awards that are announced during the show. The prediction system may score participants in both a custom game and the “open” game (e.g. a non-custom game that is open to any prediction system registrant). In one embodiment, the prediction system does not keep score; instead, data and guesses are collected and random selection is used to pick a winner.

Multiple participants can “win” by being right. In one embodiment, the prediction system maintains a running tally of participant scores enabling determination of the final winner as not only who gets the most predictions correct, but also how many widgets were wagered. The possibility of a tie may be considered in the rules and a winner can be drawn or multiple prizes awarded. For example, a first participant gets all ten predictions correct and wagers 50 widgets per pick, and a second participant gets all ten correct but chooses to wager only ten widgets per pick. The first participant will amass a higher score than the second participant, even though they got the exact same number of predictions correct.

In one embodiment, a player can choose not to enter a prediction for a particular round of a multi-round game. The lack of a response does not disqualify the participant. The participant does not lose widgets but does not gain any either. The participant may lose a default (e.g. an ante) amount if they fail to enter a prediction.

The PGFE may analyze the unique factors associated with award shows and consider these factors when generating predictions. Examples of such factors include money spent on advertising campaigns and historical factors to gauge where the award voters are leaning based on the previous awards given out during the event.

In one embodiment, the PGFE is not limited to situations that require predictive factors. Radio station play lists, concerts and birthday games are all examples of events that can be put into the database and sent out to the public so they can wager or guess what may happen next. Player ratings, teams and their needs, as well as league economy can be saved to a player by name or to a code that indicates a player. Each player and team may contain a profile.

In one embodiment, the prediction system not only provides the probability of the next pick, but will also be able to project multiple consecutive picks, thereby forecasting the remaining members of the selection pool at a future time. For example, the prediction system could predict several iterations of a NFL draft to assess the pool of players that will be available when a particular team is scheduled to pick. Such a system enables the ability to analyze a player and project a percentage of certain players being available at later points in the draft.

The participant may be offered information about public opinion regarding the likely results. What the public “likes” has a huge effect on an artist choice of songs as well as giving insight to the type of award. This informal polling is a factor in generating the prediction options, as well as calculating odds.

One embodiment of the prediction system and method is outlined below. Whether by text message, searching the web, email, radio, television or print advertising, the participant is drawn to the prediction system registration center. The individual reviews game information or finds out about advertisers or uses interactive mock prediction tools. If the participant decides to register, the participant enters personal information which includes name, address, cell phone number, email address, and personal demographic information such as age, income, sex, etc. Once this data is registered, in one embodiment, the participant is directed to another site that gathers sponsorship information such as specific questions about a product and whether or not the participant would like to be contacted regarding the products or services the sponsors provide.

Once the registration process is completed, the prediction system prompts the user to verify the registration data. The participant may be able to access “insider” information in exchange for registering. Insider information is, for instance, how a prediction system expert opinion views the draft and some of the important predictive factors that will influence the draft. The participant can check back for updated information on the event or choose to have information pushed (via, for example, email or text message) to the participant.

In one embodiment, on the day of an event, the participant receives a confirmation message on his gaming device. When the event (e.g., the NFL Draft) begins, the participant receives messages on his gaming device. An example of such a prompt from the prediction system is, “Who do you think the Detroit Lions will select in the fifth overall pick of the NFL Draft?” The prediction system then offers suggestions of several possible answers to that question. For example, in one embodiment, the prediction system lists the four most likely players to be selected by the Lions and lists the corresponding odds and/or payouts next to the player names. The message sent by the prediction system suggesting possible answers to the question posed may also include additional information about the choices that may be useful to the participant in making a prediction. For example, the prediction system lists player position or school.

The participant then uses the gaming device to communicate their prediction to the prediction system. In one embodiment, the participant is allowed not only to make a prediction from the options that have previously been presented by the prediction system but also the participant can choose options such as: “the field;” “none of the above;” or “trade pick.” The participant could also include in their text, email, or on-line a wagered amount. Designation of this information can be represented as a letter corresponding with the option (i.e. the participant's prediction) along with a number to represent their widget-based wager. A follow-up email or text or confirmation page appears to let the player know that their guess was registered. When the result is announced or revealed live at the event, another message is sent to the player to communicate the result of their prediction, and in one embodiment, his or her account balance. The process continues until the event or game has concluded over.

By bringing participants together, the prediction system offers valuable access to potential customers for advertisers. The prediction system is a source of advertising revenue and enables valuable marketing partnerships with appropriate web sites and media companies. The prediction system can also be used by professional sports teams as an advantage over their opponents on draft day. The PGFE's ability to predict which players will get selected gives sports teams a chance to corner the market on the competition by calculating value based on research, algorithms, and economic scales.

### Prediction Game for an NFL Draft

A specific embodiment for the example of a prediction game for an NFL draft is now described with reference to FIGS. 5-6. In FIG. 5, four wide receivers are illustrated who were all available for the Chargers during last year's draft at the 30^{th} pick. What had already been determined was that the Chargers needed a wide receiver. We were able to ascertain this information by watching the league as well as reading the copious amounts of reports on the internet. Of the four receivers left, our “Grade” rated Dwayne Jarrott and Sydney Rice ahead of Craig Davis and Anthony Gonzales.

The grade was determined by taking four draft experts' grades and more than five years of gauging their accuracy. Those scouts are then graded and their individual player grades are adjusted accordingly. For each individual player, the system then adds adjusted grades of the four scouts and divides by four. This can be done with less scouts or more, but this example just settled for now on these four scouts (the system actually used about six scouts over the course of our testing).

Continuing with reference to FIG. 5, once the system has the grade of the player, the system takes different attributes for different positions that impact how they might not only fit into a system, but also into a team. In the case of the wide receivers, the system chose in simplest form Size, Speed, Hands, and Ability to Separate. The system then scours all of the scouting reports to drill down on the different attributes of a player and determine whether it is a strength, weakness, or an average ability of a player. There are many other attributes that can be taken into consideration. However, it depends on how complex and accurate the participant likes to get. For this example, the system breaks out that Davis and Gonzales are more “speed” receivers, while Jarrott and Rice are more “size” receivers.

The next portion of the formula is need—what does the team need in the draft. At this point the system identifies that the wide receiver is one of the Chargers' needs. But specifically, they need a wide receiver who can stretch the field and allow them a “deep threat”. They have plenty of “possession” or “size” receivers, but they need speed. Once the system considers the importance of the need based on research and rating, the system multiplies that by each wide receiver's attribute rating and we come up with adjusted attribute ratings that reflect what the player's strengths/weaknesses are compared to what the teams needs are. The system also takes the overall need and multiplies the need by the player's grade to come up with an adjusted player grade that is in conjunction with the team need. That adjusted rating is then multiplied by the specific skill sets ratings of what the Chargers needed. This gives a final grade that is specific to the Chargers' need and the individual players' attributes. Essentially, it shows the best fit (see “Charger Grade” as shown in FIG. 6).

This “Charger Grade” is given one final filter which has to do with the economy of the league. Each team's “needs” are calculated to provide what the league needs. Each player's skill sets are then grouped to show who might fill those needs. Example, we have six teams that need a “speed” receiver to stretch the field. There are four wide receivers available that can do that. This creates an economic imbalance of more demand than supply. This is quantified and used to adjust the “Charger Grade” to give a final grade.

This process is constantly updated as economy changes and team needs change as the draft unfolds. It's this dynamic analysis that separates this approach from “mock drafts”.

### Prediction Game Process

A specific embodiment of a prediction game process is now described. In this embodiment, the system determines the selections and pushes them to the contestants as follows: A Game Engine calculates selections for a Draft/Award/Concert Model and sends the choices to a player Database. Next, the Player Database collects choices and texts, emails, or populates options to players. Next, the Player reads options and decides which choice it wants and how much it wants to wager.

This type of SMS or MMS communication that occurs instantaneously would be handled by a company like MBlox.

A registered player makes a selection and replies to the system as follows: Players text, email, or choose on-line their selection and put in a wager. Next, a Router Device routes traffic to an open server. Next, servers collect data from these choices. Next, servers drop data in the contestant data base to keep score. Next, the Database stores the player's selection and wager. Next, the Game Database tells the Contestant database the correct choice.

The system determines correct wagers (winners and losers) and pushes these results to the contestants as follows: The player database recognizes which guesses were correct and which were incorrect. The player database then does the calculations of wagers. Next, the system then pushes a “congratulations” or “sorry” to the player along with his or her new widget total.

### Additional Embodiments and Variations

For the sake of brevity, conventional data networking, application development and other functional aspects of the systems (and components of the individual operating components of the systems) may not be described in detail herein.

As used herein, the term “network” includes any electronic communications system or method which incorporates hardware and/or software components. Communication among the parties may be accomplished through any suitable communication channels, such as, for example, a telephone network, an extranet, an intranet, the Internet, point of interaction device (point of sale device, personal digital assistant (e.g. Palm Pilot®, Blackberry®, cellular phone, kiosk, etc.), online communications, satellite communications, off-line communications, wireless communications, transponder communications, local area network (LAN), wide area network (WAN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, Dilip Naik, Internet Standards and Protocols (1998); Java 2 Complete, various authors, (Sybex 1999); Deborah Ray and Eric Ray, Mastering HTML 4.0 (1997); and Loshin, TCP/IP Clearly Explained (1997) and David Gourley and Brian Totty, HTTP, The Definitive Guide (2002), the contents of which are hereby incorporated by reference.

In addition to the components described above, the system may further include one or more of the following: a host server or other computing systems including a processor for processing digital data; a memory coupled to the processor for storing digital data; an input digitizer coupled to the processor for inputting digital data; an application program stored in the memory and accessible by the processor for directing the processing of digital data by the processor; a display device coupled to the processor and memory for displaying information derived from digital data processed by the processor; and a plurality of databases.

The various system components may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g. Gilbert Held, Understanding Data Communications (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein. In one embodiment, the system, or any system component, may interact with any number of additional computing systems and databases. Computing systems and databases residing outside of the system may be administered by an authorized user and/or product provider or any other third party directly or indirectly involved in facilitating the disclosed system. Such third party may include program administrators, corporate officers, management consultants, IT support personnel, and the like.

As will be appreciated by one of ordinary skill in the art, the present disclosure may be embodied as a customization of an existing system, an add-on product, upgraded software, a standalone system (e.g. kiosk), a distributed system, a method, a data processing system, a device for data processing, and/or a computer program product. Accordingly, the present disclosure may take the form of an entirely software embodiment or an embodiment combining aspects of both software and hardware. Furthermore, the present disclosure may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

In one embodiment, the system may interact with the disclosed gaming methods via an Internet browser at a web client and/or wireless device. In another embodiment, the system may interact with the methods by way of client with a LAN connection to the various components of the system. Web client comprises any hardware and/or software suitably configured to facilitate input, receipt and/or review of any information related to the system or any information discussed herein. Web client may include a browser application installed on any device (e.g. personal computer), which communicates (in any manner discussed herein) with the disclosed systems and methods via any network discussed herein. Such browser applications comprise Internet browsing software installed within a computing unit or system to conduct online transactions and communications. These computing units or systems may take the form of a computer or set of computers, although other types of computing units or systems may be used, including laptops, notebooks, hand-held computers, set-top boxes, workstations, computer-servers, main frame computers, mini-computers, PC servers, pervasive computers, network sets of computers, and/or the like. Practitioners will appreciate that web client may or may not be in direct contact with the system. For example, web client may access the services of the system through another server, which may have a direct or indirect connection to web server.

As those skilled in the art will appreciate, web client may include an operating system (e.g. WINDOWS NT, 95/98/2000/Vista, OS2, UNIX, LINUX, SOLARIS, MAC OS, etc.) as well as various conventional support software and drivers typically associated with computers. Web client may include any suitable personal computer, network computer, workstation, minicomputer, mainframe or the like. Web client can be in a home or business environment with access to a network. In an exemplary embodiment, access is through a network or the Internet through a commercially available web-browser software package. Furthermore, web client may be independently, separately or collectively suitably coupled to the network via data links which includes, for example, a connection to an Internet Service Provider (ISP) as is typically used in connection with standard modem communication, cable modem, Dish networks, ISDN, Digital Subscriber Line (DSL), or various wireless communication methods, see, e.g. Gilbert Held, Understanding Data Communications (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

The present disclosure contemplates uses in association with web services, utility computing, pervasive and individualized computing, security and identity solutions, autonomic computing, commodity computing, mobility and wireless solutions, open source, service-oriented architecture, biometrics, grid computing and/or mesh computing.

The web server may include any hardware and/or software suitably configured to facilitate communications between web client and one or more system components. Further, web server may be configured to transmit data to web client within markup language documents. Web server may operate as a single entity in a single geographic location or as separate computing components located together or in separate geographic locations. Requests originating from web client may pass through a firewall before being received and processed at web server. As used herein, “transmit” may include sending electronic data from one system component to another over a network connection. Additionally, as used herein, “data” may include encompassing information such as commands, queries, files, data for storage, and the like in digital or any other form. Web server may provide a suitable web site or other Internet-based graphical user interface which is accessible by the system or any other authorized third party. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, InterBase, etc., may be used to provide an Active Data Object (ADO) compliant database management system.

Any of the communications, inputs, storage, databases or displays discussed herein may be facilitated through a web site having web pages. The term “web page” as it is used herein is not meant to limit the type of documents and applications that may be used to interact with the user. For example, a typical web site may include, in addition to standard HTML documents, various forms, Java applets, JavaScript, active server pages (ASP), common gateway interface scripts (CGI), extensible markup language (XML), dynamic HTML, cascading style sheets (CSS), helper applications, plug-ins, and the like. A server may include a web service that receives a request from a web server, the request including a URL (e.g. http://yahoo.com/stockquotes/ge) and an IP address (e.g. 123.56.789.98). The web server retrieves the appropriate web pages and sends the data or applications for the web pages to the IP address. Web services are applications that are capable of interacting with other applications over a communications means, such as the Internet. Web services are typically based on standards or protocols such as XML, SOAP, WSDL and UDDI. Web services methods are well known in the art, and are covered in many standard texts. See, e.g. Alex Nghiem, IT Web Services: A Roadmap For The Enterprise (2003), hereby incorporated by reference.

In one embodiment, firewall comprises any hardware and/or software suitably configured to protect system components from users of other networks. Firewall may reside in varying configurations including Stateful Inspection, Proxy based and Packet Filtering among others. Firewall may be integrated as software within web server, any other system component or may reside within another computing device or may take the form of a standalone hardware component.

In one embodiment, application server includes any hardware and/or software suitably configured to serve applications and data to a connected web client and other clients. Like web server, applications server may communicate with any number of other servers, databases and/or components through any means discussed herein or known in the art. Further, application server may serve as a conduit between web client and system components. Web server may interface with application server through any means discussed herein or known in the art including a LAN/WAN, for example. Application server may further directly and or indirectly interact with authentication server, or any other system component in response to web client, or any other system or sub-system, requests.

To control access to web server or any other component of the present disclosure, web server may invoke authentication server in response to submission of authentication credentials received at web server. In one embodiment, authentication server includes any hardware and/or software suitably configured to receive authentication credentials, encrypt and decrypt credentials, authenticate credentials, and/or grant access rights according to pre-defined privileges attached to the credentials. Authentication server may grant varying degrees of application and data level access based on login information.

In one embodiment, the system further includes a report engine. Report engine includes any hardware and/or software suitably configured to produce reports from information stored in one or more databases. Report engines are commercially available and known in the art. Report engine provides, for example, printed reports, web access to reports, graphs, real-time information, raw data, batch information and/or the like. Report engine may be implemented through commercially available hardware and/or software, through custom hardware and/or software components, or through a combination thereof. Further, report engine may reside as a standalone system or as a component of web server.

In one embodiment, any database disclosed herein includes any hardware and/or software suitably configured to facilitate storing authentication and/or privilege information relating to Login-IDs. One skilled in the art will appreciate that the present disclosure may employ any number of databases in any number of configurations. Further, any databases discussed herein may be any type of database, such as relational, hierarchical, graphical, object-oriented, and/or other database configurations. Common database products that may be used to implement the databases include DB2 by IBM (White Plains, N.Y.), various database products available from Oracle Corporation (Redwood Shores, Calif.), Microsoft Access or Microsoft SQL Server by Microsoft Corporation (Redmond, Wash.), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one aspect of the present disclosure, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In one exemplary embodiment, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g. paged memory, least recently used, etc.). By using BLOB methods, the ability to store various data sets that have different formats facilitates the storage of data associated with the present disclosure by multiple and unrelated owners of the data sets. For example, a first data set which may be stored, may be provided by a first party, a second data set which may be stored, may be provided by an unrelated second party, and yet a third data set which may be stored, may be provided by a third party unrelated to the first and second parties. Each of these three exemplary data sets may contain different information that is stored using different data storage formats and/or techniques. Further, each data set may contain subsets of data that also may be distinct from other subsets.

As stated above, in various embodiments of the present disclosure, the data can be stored without regard to a common format. However, in one exemplary embodiment of the disclosure, the data set (e.g. BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g. LOADED, INITIALIZED, READY, BLOCKED, REMOVABLE, or DELETED.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer, may be received by a standalone interaction device configured to create, update, delete or augment the data in accordance with the header or trailer. As such, in one embodiment, the header or trailer is not stored on the transaction device along with the associated issuer-owned data but instead the appropriate action may be taken by providing to the transaction instrument user at the standalone device, the appropriate option for the action to be taken. The present disclosure may contemplate a data storage arrangement wherein the header or trailer, or header or trailer history, of the data is stored on the transaction instrument in relation to the appropriate data.

One skilled in the art will also appreciate that, for security reasons, any of the databases, systems, devices, servers or other components of the present disclosure may consist of any combination thereof at a single location or at multiple locations, wherein each database or system includes any of various suitable security features, such as firewalls, access codes, encryption, decryption, compression, decompression, and/or the like.

The present disclosure may be described herein in terms of functional block components, screen shots, optional selections and various processing steps. It should be appreciated that such functional blocks may be realized by any number of hardware and/or software components configured to perform the specified functions. For example, the present disclosure may employ various integrated circuit components, e.g. memory elements, processing elements, logic elements, look-up tables, and the like, which may carry out a variety of functions under the control of one or more microprocessors or other control devices. Similarly, the software elements of the present disclosure may be implemented with any programming or scripting language such as C, C++, JAVA, COBOL, assembler, PERL, Visual Basic, SQL Stored Procedures, extensible markup language (XML), with the various algorithms being implemented with any combination of data structures, objects, processes, routines or other programming elements. Further, it should be noted that the present disclosure may employ any number of conventional techniques for data transmission, signaling, data processing, network control, and the like. Still further, the present disclosure could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

The software elements of the present disclosure may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, web pages, web sites, web forms, prompts, etc. Practitioners will appreciate that the illustrated steps described herein, or in any of the figures, may comprise any number of configurations including the use of windows, web pages, web forms, popup windows, prompts, text messages, and the like. It should be further appreciated that the multiple steps as illustrated and described may be combined into single web pages and/or interfaces but have been expanded for the sake of simplicity. In other cases, steps illustrated and described as single process steps may be separated into multiple web pages and/or interfaces but have been combined for simplicity. Although the disclosure has been described as a method, it is contemplated that it may be embodied as computer program instructions on a tangible computer-readable carrier, such as a magnetic or optical memory or a magnetic or optical disk.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the present disclosure. Reference to an element in the singular is not intended to mean “one and only one” unless explicitly so stated, but rather “one or more.” All structural, and functional equivalents to the elements of the above-described exemplary embodiments that are known to those of ordinary skill in the art are expressly incorporated herein by reference and are intended to be encompassed by the disclosure.

1. A method to provide a game in which a plurality of participants makes one or more prediction selections of possible outcomes expected for an event, the method comprising:
storing data regarding the event in at least one database or memory;
receiving the one or more prediction selections from the plurality of participants, at least one of the one or more prediction selections provided after the start of the event;
storing a plurality of prediction factors;
executing a model comprising one or more rules that use the plurality of prediction factors; and
providing, to the plurality of participants during the event, one or more actual results from the event related to the one or more prediction selections.

2. The method of claim 1, further comprising receiving a wager from the plurality of participants along with at least one of the prediction selections.

3. The method of claim 2, wherein the providing the one or more actual results comprises providing each of the plurality of participants with an updated participant score based on adjustments made due to a respective participant's wager and prediction selection.

4. The method of claim 1, further comprising dynamically adjusting the likelihood that a particular prediction selection will be chosen as a function of prior prediction selections during the event.

5. The method of claim 1, wherein the data regarding the event comprises historical data for use in conjunction with one or more expert opinions to predict future outcomes.

6. The method of claim 1, wherein the prediction factors are stored in the at least one database or memory, the prediction factors comprising information regarding a desired outcome in the event.

7. The method of claim 1, further comprising updating the prediction factors during the event by adjusting a weight associated with at least one of the prediction factors.

8. The method of claim 1, wherein the plurality of prediction factors influences the one or more prediction selections.

9. The method of claim 1, wherein the event is one of the following: a sports game, a sports draft, a concert, and an awards show.

10. The method of claim 1, further comprising sending the plurality of participants a message after the event starts, the message prompting at least one of the prediction selections.

11. The method of claim 10, wherein the message comprises a presentation of at least one possible answer for the at least one prediction selection by the plurality of participants.

12. The method of claim 1, further comprising accepting a confidence indicator from the plurality of participants along with each prediction selection, the confidence indicator comprising a weight for the prediction selection.

13. The method of claim 1, further comprising assessing a prediction accuracy for each of the plurality of participants.

14. The method of claim 1, wherein the storing data regarding the event comprises storing the one or more rules, historical data, and data about actual outcomes as the event unfolds.

15. The method of claim 1, wherein the executing the model comprises:
executing the model on at least one server; and
reading the one or more rules from an intelligent cartridge in communication with the at least one server.

16. The method of claim 1, wherein the receiving the one or more prediction selections from the plurality of participants comprises receiving one or more of the following: a text message, an email, and an entry in a web page.

17. The method of claim 1, wherein:
the prediction factors comprise information regarding a type of player that a sports team seeks to draft; and
the executing the model comprises:
determining grades for at least two experts based on historical accuracy;
adjusting grades for a plurality of individual players based on the grades for the at least two experts; and
searching player data, comprising the adjusted grades for the plurality of individual players, based on a selected set of player attributes.

18. The method of claim 17, wherein the executing the model further comprises:
updating the prediction factors after the start of the draft; and
adjusting the grades for the plurality of individual players based on results from the updating the prediction factors.

19. A computer-readable medium embodying instructions, the instructions causing a data processing system to perform a method to provide a game in which a plurality of participants makes one or more prediction selections of possible outcomes expected for an event, the method comprising:
storing data regarding the event in at least one database or memory;
receiving the one or more prediction selections from the plurality of participants, at least one of the one or more prediction selections provided after the start of the event;
storing a plurality of prediction factors;
executing a model comprising one or more rules that use the plurality of prediction factors; and
providing, to the plurality of participants during the event, one or more actual results from the event related to the one or more prediction selections.

20. A system to provide a game in which a plurality of participants makes one or more prediction selections of possible outcomes expected for an event, the system comprising:
means for storing data regarding the event in at least one database or memory;
means for receiving the one or more prediction selections from the plurality of participants, at least one of the one or more prediction selections provided after the start of the event;
means for storing a plurality of prediction factors;
means for executing a model comprising one or more rules that use the plurality of prediction factors; and
means for providing, to the plurality of participants during the event, one or more actual results from the event related to the one or more prediction selections
